(19) United States
(12) Patent Application Publication
(10) Pub. No.: US 2017/0138254 A1
(43) Pub. Date: May 18, 2017

(54) BALANCE SHAFT DISCONNECT FOR ENGINE SPIN LOSS REDUCTION

(71) Applicant: GM GLOBAL TECHNOLOGY OPERATIONS LLC, Detroit, MI (US)

(72) Inventors: Andrei Balaceanu, Whitby (CA); Dale E Murrish, Troy, MI (US)

(73) Assignee: GM GLOBAL TECHNOLOGY OPERATIONS LLC, Detroit, MI (US)

(21) Appl. No.: 14/939,532

(22) Filed: Nov. 12, 2015

(51) Int. Cl. F02B 75/06; F16F 15/26

(52) U.S. Cl. CPC F02B 75/06; F16F 15/265; F16F 2222/08; F16F 2230/0011

(57) ABSTRACT

An engine includes a crankshaft rotatable about a crank axis, and at least one balance shaft rotatable about a respective balance axis. The balance shaft rotates about the balance axis to balance the engine during rotation of the crankshaft about the crank axis. A torque transmitting mechanism is selectively moveable between an engaged position and a disengaged position. When the torque transmitting mechanism is disposed in the engaged position, the torque transmitting mechanism connects the crankshaft and the balance shaft in torque communication for rotating the balance shaft with the crankshaft to balance the engine, and when disposed in the disengaged position, the torque transmitting mechanism disconnects torque communication between the crankshaft and the balance shaft for not rotating the balance shaft with the crankshaft as the crankshaft rotates about the crank axis, to reduce spin losses of the engine.

### TECHNICAL FIELD

The disclosure generally relates to an internal combustion engine, and a method of controlling the internal combustion engine.

### BACKGROUND

Internal combustion engines include a crankshaft that rotates about a crank axis. When possible, the engine is balanced to eliminate or minimize vibration caused by the crankshaft and reciprocating components rotating about the crank axis. Engine vibration caused by the crankshaft and the large end of the connecting rods and rod bearings can be balanced by counterweights on the crankshaft. However, the slider-crank mechanism on single or multi-cylinder engines causes primary and secondary forces and couples which are not inherently balanced because of the reciprocating mass and arrangement of the cylinders relative to each other. As used herein, the term “couple” or “couples” is defined as a pair of parallel forces acting in opposite directions and tending to produce rotation. Some engine configurations, particularly in-line four cylinder engines for example, cannot be balanced.

In order to smooth the operation and reduce engine vibration, some internal combustion engines are equipped with a balancing shaft or shafts, typically two counter-rotating balancing shafts which rotate at twice engine speed, to balance the engine as the crankshaft rotates about the crank axis. In-line three cylinder engines and 90 degree V6 engines have a primary couple which can be balanced by a single shaft rotating at engine speed in a direction opposite to the engine's rotation. In-line six cylinder engines are inherently balanced. Ninety degree V8 engines with conventional cross-plane crankshafts have a primary rotating couple which can be balanced with crankshaft counterweights. Some in-line five cylinder engines have been balanced with twin counter-rotating shafts rotating at twice engine speed.

The balancing shafts are coupled to and rotatably driven by the crankshaft, such as through a gear, belt, or chain drive. The coordinated rotation of the balancing shaft or shafts with the crankshaft balances and smoothens the operation of the engine. The engine inertial imbalance becomes more significant at higher engine rotational speeds, whereas the engine inertia imbalance is less significant and it may not be objectionable to the vehicle occupants at lower engine rotational speeds. Some smaller displacement engines do not need balance shafts because the reciprocating forces are small enough to not be a problem.

### SUMMARY

An internal combustion engine is provided. The internal combustion engine includes a block, and a crankshaft supported by the block. The crankshaft is rotatable about a crank axis relative to the block. A first balance shaft is supported by the block or a balance shaft housing, and is rotatable about a first balance axis relative to the block or the balance shaft housing. The first balance shaft rotates about the first balance axis to balance the engine during rotation of the crankshaft about the crank axis. A torque transmitting mechanism is selectively moveable between an engaged position and a disengaged position. When the torque transmitting mechanism is disposed in the engaged position, the torque transmitting mechanism connects the crankshaft and the first balance shaft in torque communication for rotating the first balance shaft with the crankshaft. When the torque transmitting mechanism is disposed in the disengaged position, the torque transmitting mechanism disconnects torque communication between the crankshaft and the first balance shaft for not rotating the first balance shaft with the crankshaft as the crankshaft rotates about the crank axis.

A method of controlling an internal combustion engine is also provided. The internal combustion engine includes a crankshaft and at least one balance shaft for balancing the engine during rotation of the crankshaft about a crank axis. The method includes sensing a rotational speed of the crankshaft with a rotational speed sensor. A torque transmitting mechanism is signaled with an engine control module, to connect torque communication between the crankshaft and the balance shaft when the rotational speed of the crankshaft is equal to or greater than a rotational speed threshold. The torque transmitting mechanism is signaled with the engine control module to disconnect torque communication between the crankshaft and the balance shaft when the rotational speed of the crankshaft is less than the rotational speed threshold.

Accordingly, the balancing shaft may be engaged to balance the engine by positioning the torque transmitting mechanism in the engaged position, and the balancing shaft may be disengaged to not affect the crankshaft when the torque transmitting mechanism is disposed in the disengaged position. When the torque transmitting mechanism is disposed in the disengaged position, the internal combustion engine does not incur any energy losses associated with rotating the balancing shaft. As such, disengaging the balancing shaft increases the operating efficiency of the engine. The torque transmitting mechanism may be moved into the disengaged position to disengage the balancing shaft during low engine rotational speeds, when vibration in the engine is not noticeable, thereby reducing energy losses in the engine. The torque transmitting mechanism may be moved into the engaged position to engage the balance shaft and balance the engine during high engine rotational speeds, when vibration in the engine increases and would otherwise be noticeable.

Friction is proportional to diameter cubed times length of journal bearings, and also to rotational speed squared. Accordingly, there is a greater friction benefit for decoupling the balance shafts from an engine with secondary balance shafts (which rotate at twice engine speed) than a primary shaft because of the number of bearings and the rotational speed of the balance shafts.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic perspective view of an internal combustion engine.

FIG. 2 is a schematic side view of the internal combustion engine.

FIG. 3 is a schematic side view of a first alternative embodiment of the internal combustion engine.

FIG. 4 is a schematic front view of a second alternative embodiment of the internal combustion engine.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Referring to the Figures, wherein like numerals indicate like parts throughout the several views, an internal combustion engine is generally shown at 20. The internal combustion engine 20 may include, but is not limited to a gasoline engine or a diesel engine, and may be configured in any suitable style and/or configuration. While the teachings of the disclosure are particularly relevant to engine configurations which are not inherently balanced, such as but not limited to an in-line four cylinder engine configuration, it should be appreciated that the teachings of the disclosure may be applied to any style and/or configuration of the internal combustion engine 20.

The internal combustion engine 20 includes an engine block 24. The block 24 rotatably supports the crankshaft 22. A plurality of pistons (not shown) are attached to the crankshaft 22 via connecting rods and piston pins (not shown), and move in a reciprocating motion within cylinder bores (not shown) defined by the block 24. Combustion of fuel in the cylinder bores drives the pistons, which cause the crankshaft 22 to rotate relative to the block 24, about a crank axis 26, as is known in the art.

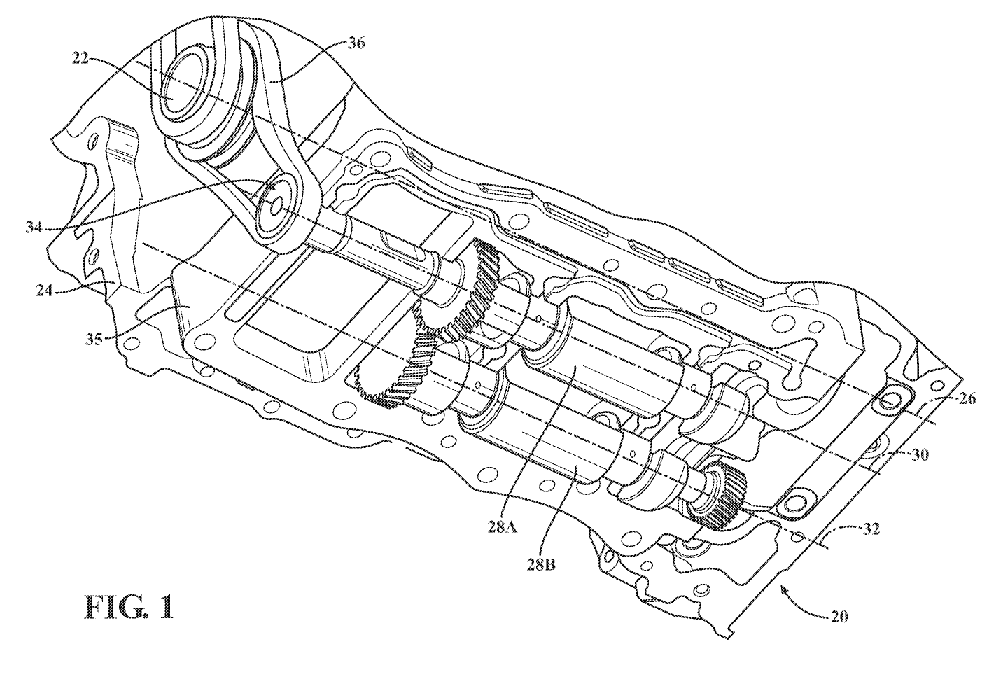

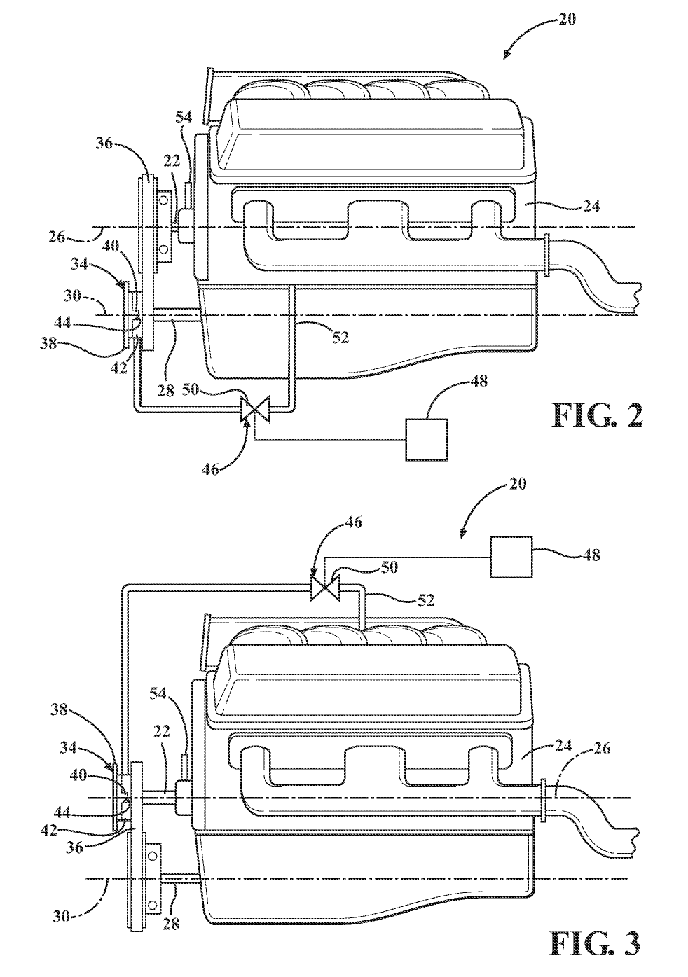

Referring to FIGS. 1 and 2, the internal combustion engine 20 further includes at least one balance shaft 28. As shown in FIG. 1, the exemplary embodiment of the internal combustion engine 20 includes a first balance shaft 28A and a second balance shaft 28B. The balance shafts 28 (including both the first balance shaft 28A and the second balance shaft 28B) are referred to generally by the reference numeral 28, whereas the first balance shaft is referred to specifically by the reference numeral 28A, and the second balance shaft is referred to specifically by the reference numeral 28B. The first balance shaft 28A is rotatably supported by the block 24, and is rotatable about a first balance axis 30 relative to the block 24. The first balance shaft 28A may be directly supported by the block 24, or may be indirectly supported by the block via a balance shaft housing 35, which is in turn attached to the block 24. The second balance shaft 28B is rotatably supported by the block 24, and is rotatable about a second balance axis 32. The second balance shaft 28B may be directly supported by the block 24, or may be indirectly supported by the block via the balance shaft housing 35, which is in turn attached to the block 24. The first balance shaft 28A and the second balance shaft 28B rotate about the first balance axis 30 and the second balance axis 32 respectively, to balance the engine 20 during rotation of the crankshaft 22 about the crank axis 26. Balancing the engine 20 as the crankshaft 22 rotates about the crank axis 26 reduces vibration in the internal combustion engine 20, as is known in the art. The manner in which the first balance shaft 28A and the second balance shaft 28B operate to balance the crankshaft 22 is known in the art, and is therefore not described in detail herein.

A torque transmitting mechanism 34 connects and disconnects torque communication between the first balance shaft 28A, the second balance shaft 28B, and the crankshaft 22. The torque transmitting mechanism 34 is selectively moveable between an engaged position and a disengaged position. When disposed in the engaged position, the torque transmitting mechanism 34 connects torque communication between the crankshaft 22 and both the first balance shaft 28A and the second balance shaft 28B. The torque transmitting mechanism 34 connects torque communication between the crankshaft 22, the first balance shaft 28A, and the second balance shaft 28B to rotate the first balance shaft 28A and the second balance shaft 28B with the crankshaft 22. When the torque transmitting mechanism 34 is disposed in the disengaged position, the torque transmitting mechanism 34 disconnects torque communication between the crankshaft 22 and both the first balance shaft 28A and the second balance shaft 28B. The torque transmitting mechanism 34 disconnects torque communication between the crankshaft 22, the first balance shaft 28A, and the second balance shaft 28B so that the crankshaft 22 does not rotate the first balance shaft 28A or the second balance shaft 28B, as the crankshaft 22 rotates about the crank axis 26.

The specific configuration of the torque transmitting mechanism 34, and the manner in which the torque transmitting mechanism 34 operates to connect and disconnect torque communication between the crankshaft 22, the first balance shaft 28A, and the second balance shaft 28B, is dependent upon the specific manner in which torque is transmitted from the crankshaft 22 to the first balance shaft 28A and the second balance shaft 28B. In the exemplary embodiment of the internal combustion engine 20 shown in FIGS. 1 and 2, an endless rotatable device 36 interconnects the crankshaft 22 and the torque transmitting mechanism 34. The torque transmitting mechanism 34 connects and disconnects the torque communication between the endless rotatable device 36 and the first balance shaft 28A. The second balance shaft 28B is rotatably driven by the first balance shaft 28A, through a pair of intermeshing gears. The endless rotatable device 36 may include but is not limited to, a belt or a chain. The endless rotatable device 36 is used to transfer torque from the crankshaft 22 to the first balance shaft 28A, in order to rotate the first balance shaft 28A and the second balance shaft 28B about the first balance axis 30 and the second balance axis 32 respectively. However, it should be appreciated that the crankshaft 22 may be coupled to the balance shafts 28 in some other manner, other than with the endless rotatable device 36, such as through a direct gear drive. In the exemplary embodiment shown in the Figures and described herein, when the torque transmitting mechanism 34 is engaged, the torque transmitting mechanism 34 is actuated to transfer rotation, i.e., torque, from the endless rotatable device 36 to the first balance shaft 28A. When the torque transmitting mechanism 34 is disengaged, the torque transmitting mechanism 34 is actuated to prevent the transfer of rotation, i.e., torque, from the endless rotatable device 36 to the first balance shaft 28A.

In the exemplary embodiment of the internal combustion engine 20 shown in FIGS. 1 and 2, the torque transmitting mechanism 34 may include, but is not limited to a gear synchronizer, or a clutch. However, it should be appreciated that other embodiments may include the torque transmitting mechanism 34 configured to include a device other than a meshing gear synchronizer or a clutch. As is appreciated by those skilled in the art, a gear synchronizer is a device that enables the smooth engagement between meshing gears, and a clutch is a device for coupling and decoupling two rotating components. The torque transmitting mechanism 34 may include any device that is capable of being selectively controlled between the engaged position and the disengaged position, to selectively connect and/or disconnect torque communication between two elements.

The torque transmitting mechanism 34 is configured and/or sized to provide an adequate rate of increasing torque communication, in order to accelerate the balance shafts 28 from a rotational speed of zero to a rotational speed corresponding to the threshold crankshaft rotational speed, while connecting full torque communication between the balance shafts 28 to the crankshaft 22 in a reasonable amount of time. The torque transmitting mechanism 34 may be configured and/or sized to connect torque communication between the balance shafts 28 and the crankshaft 22 to provide an engagement rate that provides a seamless engagement action that is not generally noticeably to an occupant. The torque transmitting mechanism 34 may be sized based on the moment of inertia of the balance shafts 28, and the amount of torque transmitted between the crankshaft 22 and the balance shafts 28.

The torque transmitting mechanism 34 may be attached to and supported by one of the crankshaft 22, the first balance shaft 28A, and/or the second balance shaft 28B. Preferably, and in the exemplary embodiment shown in FIGS. 1 and 2, the torque transmitting mechanism 34 is attached to and supported by the first balance shaft 28A. Accordingly, when the torque transmitting mechanism 34 is disposed in the engaged position, the torque transmitting mechanism 34 connects torque communication between the first balance shaft 28A and the endless rotatable device 36 to transmit torque between the crankshaft 22 and the first balance shaft 28A. When the torque transmitting mechanism 34 is disposed in the disengaged position, the torque transmitting mechanism 34 disconnects torque communication between the endless rotating device 36 and the first balance shaft 28A, thereby preventing torque transfer between the crankshaft 22 and the first balance shaft 28A, and also the second balance shaft 28B, since the second balance shaft 28B is driven by the first balance shaft 28A via a gear to gear interface which accomplishes the reversing requirement of the balance shafts 28.

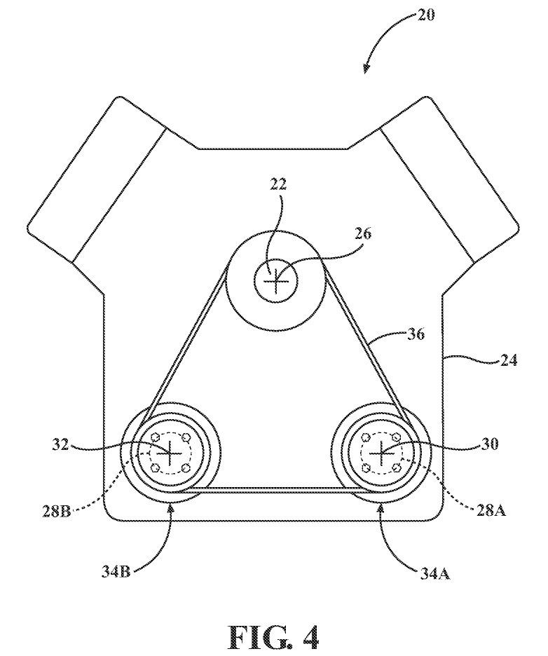

Referring to FIG. 3, an alternative embodiment of the internal combustion engine 20 is shown, in which the torque transmitting mechanism is attached to and supported by the crankshaft 22 for connecting and disconnecting the crankshaft 22 and the endless rotating device 36. The endless rotating device 36 is continuously disposed in torque communication with the first balance shaft 28A. Accordingly, when the torque transmitting mechanism 34 is disposed in the engaged position, the torque transmitting mechanism 34 connects torque communication between the crankshaft 22 and the endless rotating device 36 to transfer torque to the first balance shaft 28A. When the torque transmitting mechanism 34 is disposed in the disengaged position, the torque transmitting mechanism 34 disconnects torque communication between the crankshaft 22 and the first balance shaft 28A, so that the first balance shaft 28A is not driven to rotate about the first balance axis 30.

Referring to FIG. 4, a second alternative embodiment of the internal combustion engine 20 is shown, in which the internal combustion engine 20 includes two torque transmitting mechanisms 34A, 34B, with a first torque transmitting mechanism 34A attached to and supported by the first balance shaft 28A, and a second torque transmitting mechanism 34B attached to and supported by the second balance shaft 28B. In such a configuration, the two torque transmitting mechanisms 34A, 34B would be simultaneously engaged or disengaged to respectively connect or disconnect the first balance shaft 28A and the second balance shaft 28B from the endless rotatable device 36. It should be appreciated that in the engine configuration shown in FIG. 4, the first balance shaft 28A and the second balance shaft 28B are rotatably driven independently of each other, and do not include the meshing gears shown in FIG. 1. Furthermore, it should be appreciated that in the embodiment shown in FIG. 4, one of the first balance shaft 28A or the second balance shaft 28B may require a reversing mechanism that reverses the rotation of that respective balance shaft relative to the other balance shaft.

As is known in the art, rotation of the balance shafts 28 must be timed with the rotation of the crankshaft 22 to properly balance the engine 20. Accordingly, the torque transmitting mechanism 34 is configured to include only a single locating position that connects the first balance shaft 28A and the second balance shaft 28B in only a single position relative to the crankshaft 22. The single locating position is designed to ensure that when the torque transmitting mechanism 34 is disposed in the engaged position, the first balance shaft 28A and the second balance shaft 28B are properly oriented relative to the crankshaft 22, so that the first balance shaft 28A and the second balance shaft 28B are properly timed with the crankshaft 22.

For example, referring to FIG. 2, the torque transmitting mechanism 34 may include two rotating rings, with a first rotating ring 38 defining a locating tooth 40, and a second rotating ring 42 defining a locating slot 44. When the locating tooth 40 and the locating slot 44 are aligned along a respective axis, the first rotating ring 38 and the second rotating ring 42 may move toward each other, with the locating tooth 40 engaged within the locating slot 44 to prevent relative rotation between the first rotating ring 38 and the second rotating ring 42, and to enable torque communication between the respective components attached to the torque transmitting mechanism 34. The locating tooth 40 and the locating slot 44 are positioned so that when they are aligned, the balance shafts 28 are properly oriented relative to the crankshaft 22 to balance the engine 20.

Referring to FIG. 2, an actuator 46 is coupled to the torque transmitting mechanism 34. The actuator 46 is operable to control movement of the torque transmitting mechanism 34 between the engaged position and the disengaged position, in response to a control signal. The control signal is provided by an engine control module 48, described in greater detail below. The actuator 46 may include any device capable of moving the torque transmitting mechanism 34 between the engaged position and the disengaged position. For example, the actuator 46 may include an electrically actuated device, such as an electrically actuated solenoid valve 50, that is operable to selectively couple the torque transmitting mechanism 34 to a fluid pressure source 52. The valve 50 may open and/or close fluid communication between the fluid pressure source 52 and the torque transmitting mechanism 34 to move the torque transmitting mechanism 34 between the engaged position and the disengaged position. The solenoid valve 50 may open and or close fluid communication, based on the signal from the engine control module 48. The fluid pressure source 52 may include, but is not limited to, an engine oil circulating through the block 24 under pressure. However, it should be appreciated that some other fluid pressure source 52 may be used. For example, the torque transmitting mechanism 34 may have a dedicated fluid pressure source 52.

While the exemplary embodiment of the internal combustion engine 20 described herein and shown in the Figures defines the actuator 46 as the solenoid valve 50 controlling fluid communication between the fluid pressure source 52 and the torque transmitting mechanism 34, it should be appreciated that the actuator 46 may be configured differently, and may include some other device capable of actuating the torque transmitting mechanism 34, such as but not limited to an electrically actuated device, hydraulically actuated device, or a pneumatically actuated device.

As noted above, the engine control module 48 is coupled to the torque transmitting mechanism 34, and is operable to control actuation of the torque transmitting mechanism 34 between the engaged position and the disengaged position. Preferably, the engine control module 48 is operable to position the torque transmitting mechanism 34 in the engaged position when a rotational speed of the crankshaft 22 is equal to or greater than a rotational speed threshold. The engine control module 48 is operable to position the torque transmitting mechanism 34 in the disengaged position when the rotational speed of the crankshaft 22 is less than the rotational speed threshold.

The engine control module 48 may include a computer and/or processor, and include all software, hardware, memory, algorithms, connections, sensors, etc., necessary to manage and control the operation of the internal combustion engine 20. As such, a method, described below, may be embodied as a program operable on the engine control module 48. It should be appreciated that the engine control module 48 may include any device capable of analyzing data from various sensors, comparing data, making the necessary decisions required to control the operation of the torque transmitting mechanism 34, and executing the required tasks necessary to control the operation of the torque transmitting mechanism 34.

The engine control module 48 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics.

The computer-readable memory may include any non-transitory/tangible medium which participates in providing data or computer-readable instructions. Memory may be non-volatile or volatile. Non-volatile media may include, for example, optical or magnetic disks and other persistent memory. Example volatile media may include dynamic random access memory (DRAM), which may constitute a main memory. Other examples of embodiments for memory include a floppy, flexible disk, or hard disk, magnetic tape or other magnetic medium, a CD-ROM, DVD, and/or any other optical medium, as well as other possible memory devices such as flash memory.

The engine control module 48 includes tangible, non-transitory memory on which are recorded computer-executable instructions, including an engine balancing control algorithm. The processor of the engine control module 48 is configured for executing the engine balancing control algorithm. The engine balancing control algorithm implements a method of engaging and disengaging the torque transmitting mechanism 34, to engage and/or disengage the balance shafts 28 of the internal combustion engine 20.

The method of controlling the internal combustion engine 20 to engage and/or disengage the torque transmitting mechanism 34 includes sensing a rotational speed of the crankshaft 22 with a rotational speed sensor 54. The rotational speed sensor 54 may include any sensor capable of sensing or otherwise determining the rotational speed of the crankshaft 22. For example, the rotational speed sensor 54 may include a crankshaft 22 position sensor that senses a rotational position of the crankshaft 22, and communicates the sensed position of the crankshaft 22 over time to the engine control module 48, which may then determine the rotational speed of the crankshaft 22.

The engine control module 48 may then compare the rotational speed of the crankshaft 22 to a rotational speed threshold. The rotational speed threshold is a pre-defined rotational speed. The rotational speed threshold may be defined to equal any rotational speed, and is dependent upon the specific type, size, and/or configuration of the internal combustion engine 20, as well as the specific application of the internal combustion engine 20. For example, the rotational speed threshold may be defined to equal a value that correlates to a rotational speed of the crankshaft 22, below which vibration from the unbalanced crankshaft 22 is either not noticeable or is negligible, and above which is noticeable. For example, in one exemplary embodiment, the rotational speed threshold may be defined to equal a rotational speed of 2,800 revolutions per minute.

If the engine control module 48 determines that the rotational speed of the crankshaft 22 is equal to or greater than the rotational speed threshold, then the engine control module 48 may signal the actuator 46 to position the torque transmitting mechanism 34 in the engaged position to connect torque communication between the crankshaft 22 and the balance shafts 28. In one exemplary embodiment, signaling the actuator 46 to position the torque transmitting mechanism 34 in the engaged position may include signaling the solenoid valve 50 to open or close fluid communication between the fluid pressure source 52 and the torque transmitting mechanism 34 to position the torque transmitting mechanism 34 in the engaged position and establish torque communication between the crankshaft 22 and the balance shafts 28.

If the engine control module 48 determines that the rotational speed of the crankshaft 22 is less than the rotational speed threshold, then the engine control module 48 may signal the actuator 46 to position the torque transmitting mechanism 34 in the disengaged position to disconnect torque communication between the crankshaft 22 and the balance shafts 28. In one exemplary embodiment, signaling the actuator 46 to position the torque transmitting mechanism 34 in the disengaged position may include signaling the solenoid valve 50 to open or close fluid communication between the fluid pressure source 52 and the torque transmitting mechanism 34 to position the torque transmitting mechanism 34 in the disengaged position and prevent torque communication between the crankshaft 22 and the balance shafts 28.

In order to avoid excessive engagement and disengagement of the balance shafts 28 when the engine 20 is operating around the connecting and disconnecting threshold crankshaft rotational speed, the control algorithm may include actuation hysteresis. This hysteresis may be achieved by setting different crankshaft rotational speed values for connecting and disconnecting the balance shafts 28, along with specific algorithm conditions. These control algorithm conditions may include, but are not limited to, minimum time limits for the crankshaft rotational speed to be above or below the crankshaft rotational peed values for engaging and disengaging the balance shafts 28.

By following the above described process, the engine control module 48 may control the torque transmitting mechanism 34 so that the balance shafts 28 are only being rotated when the crankshaft 22 is rotating at high rotational speeds, and engine vibration becomes noticeable. During most driving conditions, the crankshaft 22 operates at rotational speeds less than the rotational speed threshold, engine vibration is not noticeable, and therefore the internal combustion engine 20 does not require the use of the balance shafts 28 to balance the engine 20. By disengaging the balance shafts 28, the spin losses associated with rotating the balance shafts 28 at these lower rotational speeds may be eliminated. The balance shafts 28 may be engaged at higher rotational speeds to balance the engine 20, and reduce vibration in the internal combustion engine 20.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. An internal combustion engine comprising:
a block;
a crankshaft supported by the block and rotatable about a crank axis relative to the block;
a first balance shaft supported by the block and rotatable about a first balance axis relative to the block for balancing the internal combustion engine during rotation of the crankshaft about the crank axis; and
a torque transmitting mechanism selectively moveable between an engaged position connecting the crankshaft and the first balance shaft in torque communication for rotating the first balance shaft with the crankshaft, and a disengaged position disconnecting torque communication between the crankshaft and the first balance shaft as the crankshaft rotates about the crank axis.

2. The internal combustion engine set forth in claim 1 wherein the torque transmitting mechanism includes one of a gear synchronizer or a clutch for moving the torque transmitting mechanism between the engaged position and the disengaged position.

3. The internal combustion engine set forth in claim 1 wherein the torque transmitting mechanism is attached to and supported by one of the crankshaft or the first balance shaft.

4. The internal combustion engine set forth in claim 1 further comprising a second balance shaft supported by the block, and rotatable about a second balance axis relative to the block for balancing the internal combustion engine during rotation of the crankshaft about the crank axis.

5. The internal combustion engine set forth in claim 4 wherein the torque transmitting mechanism connects torque communication between the crankshaft and both of the first balance shaft and the second balance shaft when disposed in the engaged position, and wherein the torque transmitting mechanism disconnects torque communication between the crankshaft and both the first balance shaft and the second balance shaft when disposed in the disengaged position.

6. The internal combustion engine set forth in claim 5 wherein the torque transmitting mechanism is attached to and supported by the crankshaft.

7. The internal combustion engine set forth in claim 5 wherein the torque transmitting mechanism is attached to and supported by the first balance shaft, and wherein the second balance shaft is rotatably driven by the first balance shaft.

8. The internal combustion engine set forth in claim 1 wherein the torque transmitting mechanism includes only a single locating position connecting the first balance shaft in only a single position relative to the crankshaft when the torque transmitting mechanism is disposed in the engaged position so that the first balance shaft is timed with the crankshaft.

9. The internal combustion engine set forth in claim 1 further comprising an engine control module coupled to the torque transmitting mechanism and operable to control actuation of the torque transmitting mechanism between the engaged position and the disengaged position, wherein the engine control module is operable to position the torque transmitting mechanism in the engaged position when a rotational speed of the crankshaft is equal to or greater than a rotational speed threshold, and wherein the engine control module is operable to position the torque transmitting mechanism in the disengaged position when the rotational speed of the crankshaft is less than the rotational speed threshold.

10. The internal combustion engine set forth in claim 1 further comprising an actuator coupled to the torque transmitting mechanism, and operable to control movement of the torque transmitting mechanism between the engaged position and the disengaged position in response to a control signal.

11. The internal combustion engine set forth in claim 10 wherein the actuator includes a valve operable to selectively couple the torque transmitting mechanism to a fluid pressure source for moving the torque transmitting mechanism between the engaged position and the disengaged position.

12. The internal combustion engine set forth in claim 11 wherein the fluid pressure source includes an engine oil circulating through the block under pressure.

13. The internal combustion engine set forth in claim 10 wherein the actuator includes an electrically actuated device.

14. The internal combustion engine set forth in claim 1 further comprising an endless rotatable device interconnecting the crankshaft and the first balance shaft with the torque transmitting mechanism.

15. The internal combustion engine set forth in claim 14 wherein the endless rotatable device includes one of a belt or a chain.

16. An internal combustion engine comprising:
a crankshaft rotatable about a crank axis;
a balance shaft rotatable about a balance axis for balancing the internal combustion engine during rotation of the crankshaft about the crank axis; and
a torque transmitting mechanism selectively moveable between an engaged position connecting the crankshaft and the balance shaft in torque communication for rotating the balance shaft with the crankshaft, and a disengaged position disconnecting torque communication between the crankshaft and the balance shaft for not rotating the balance shaft with the crankshaft as the crankshaft rotates about the crank axis;
wherein the torque transmitting mechanism includes only a single locating position connecting the torque transmitting mechanism in only a single position relative to either one of the crankshaft or the balance shaft when the torque transmitting mechanism is disposed in the engaged position, so that the balance shaft is timed with the crankshaft.

17. The internal combustion engine set forth in claim 16 wherein the torque transmitting mechanism includes one of a gear synchronizer or a clutch.

18. A method of controlling an internal combustion engine having a crankshaft and a balance shaft for balancing the internal combustion engine during rotation of the crankshaft about a crank axis, the method comprising:
sensing a rotational speed of the crankshaft with a rotational speed sensor;
signaling a torque transmitting mechanism with an engine control module, to connect torque communication between the crankshaft and the balance shaft when the rotational speed of the crankshaft is equal to or greater than a rotational speed threshold; and
signaling the torque transmitting mechanism with the engine control module to disconnect torque communication between the crankshaft and the balance shaft when the rotational speed of the crankshaft is less than the rotational speed threshold.

19. The method set forth in claim 18 wherein:
signaling the torque transmitting mechanism to connect torque communication between the crankshaft and the balance shaft includes signaling a valve to open fluid communication between a fluid pressure source and the torque transmitting mechanism to position the torque transmitting mechanism in an engaged position to connect torque communication between the crankshaft and the balance shaft; and
signaling the torque transmitting mechanism to disconnect torque communication between the crankshaft and the balance shaft includes signaling the valve to block fluid communication between the fluid pressure source and the torque transmitting mechanism to position the torque transmitting mechanism in a disengaged position to disconnect torque communication between the crankshaft and the balance shaft.

20. The method set forth in claim 18 wherein signaling the torque transmitting mechanism to connect torque communication between the crankshaft and the balance shaft and signaling the torque transmitting mechanism to disconnect torque communication between the crankshaft and the balance shaft is dependent upon on a hysteresis of the rotational speed of the crankshaft to avoid excessive connection and disconnection of the balance shaft and the crankshaft when the crankshaft is rotating near the rotational speed threshold.
